(19) United States
(12) Patent Application Publication
(10) Pub. No.: US 2024/0243939 A1
(43) Pub. Date: Jul. 18, 2024

(54) INFORMATION PROCESSING METHOD AND APPARATUS, TERMINAL, AND STORAGE MEDIUM

(71) Applicant: Beijing Zitiao Network Technology Co., Ltd., Beijing (CN)

(72) Inventors: Liaoyuan NING, Beijing (CN); Cong WANG, Beijing (CN); Xinru ZHANG, Beijing (CN); Guangyu ZHANG, Beijing (CN); Geliang TIAN, Beijing (CN); Ying XIAO, Beijing (CN)

(21) Appl. No.: 18/561,679

(22) PCT Filed: Jul. 22, 2022
(86) PCT No.: PCT/CN2022/107352

§ 371 Date: Nov. 16, 2023

(30) Foreign Application Priority Data
Jul. 23, 2021 (CN) 202110838725.8
Aug. 12, 2021 (CN) 202110924603.0

(51) Int. Cl. H04L 12/18; H04L 51/04

(52) U.S. Cl. CPC H04L 12/1822; H04L 51/04

(57) ABSTRACT

The disclosure provides an information processing method, apparatus, terminal, and storage medium. In some embodiments, the disclosure provides an information process method comprising: determining, in response to reception of first information at an information processing interface, a first target group of the first information, and determining at least one second target group based on the first target group of the first information; and sending a first message derived based on the first information to the first target group and the at least one second target group; wherein the information processing interface is an interface other than a communication interface of the first target group and a communication interface of the second target group.

### CROSS-REFERENCE TO RELATED APPLICATION(S)

This application claims the benefit of Chinese Patent Application No. 202110838725.8 titled “Information processing method and apparatus, terminal, and storage medium” filed Jul. 23, 2021 and the benefit of Chinese Patent Application No. 202110924603.0 titled “Information processing method and apparatus, terminal, and storage medium” filed Aug. 12, 2021, which are incorporated herein by reference in their entirety.

### FIELD

The present disclosure generally relates to computer technologies, and more particularly, relates to an information processing method, an information processing apparatus, a terminal, and a storage medium.

### BACKGROUND

More and more companies have been diverted to collaboration tools to connect work across their organization. A plurality of groups are created among collaborative employees to post information; and sometimes, information in one group is forwarded manually to another group so as to share information among multiple groups.

### SUMMARY

The disclosure provides an information processing method, an information processing apparatus, a terminal, and a storage medium.

The disclosure adopts a technical solution infra.

In some embodiments of the disclosure, there is provided an information processing method, comprising:
determining, in response to reception of first information at an information
processing interface, a first target group of the first information, and determining at least one second target group based on the first target group of the first information; and
sending a first message derived based on the first information to the first target group and the at least one second target group; wherein the information processing interface is an interface other than a communication interface of the first target group and a communication interface of the second target group.

In some embodiments of the disclosure, there is provided an information processing method, comprising:
determining, in response to reception of first information at a communication interface of a first group, a target identifier bound with the first group and a set of groups bound with the target identifier;
determining at least one second group based on an association relationship between the first group and respective groups in the set of groups; and
sending a first message derived based on the first information to the first group and the at least one second group.

In some embodiments of the disclosure, there is provided an information processing apparatus, comprising:
a first determining unit configured to determine, in response to reception of first information at an information processing interface, a first target group of the first information, and determine at least one second target group based on the first target group of the first information; and
a first sending unit configured to send a first message derived based on the first information to the first target group and the second target group;
wherein the information processing interface is an interface other than a communication interface of the first target group and a communication interface of the second target group.

In some embodiments of the disclosure, there is provided an information processing apparatus, comprising:
a second determining unit configured to determine, in response to reception of first information at a communication interface of a first group, a target identifier bound with the first group and a set of groups bound with the target identifier, and determine at least one second group based on an association relationship between the first group and respective groups in the set of groups; and
a second sending unit configured to send a first message derived based on the first information to the first group and the at least one second group.

In some embodiments of the disclosure, there is provided a terminal comprising: at least one memory and at least one processor;
wherein the memory stores program codes, and the processor is configured to invoke the program codes stored on the memory to perform the methods noted supra.

In some embodiments of the disclosure, there is provided a computer-readable storage medium having program codes stored thereon, which, when executed by a processor, cause the processor to perform the method noted supra.

In some embodiments of the disclosure, in response to reception of first information at an information processing interface, a first target group of the first information is determined, and at least one second target group is determined based on the first target group of the first information; and a first message derived based on the first information is sent to the first target group and the second target group; wherein the information processing interface is an interface other than a communication interface of the first target group and a communication interface of the second target group. In the embodiments of the disclosure, after the first information is inputted in the information processing interface, on sending the first message to the first target group, the first message can be sent to the second target group, thereby enabling multi-group message sending, so that a user does not need to manually send the first message to the second target group and a need of joining the first target group and the second target group may also be eliminated.

### BRIEF DESCRIPTION OF THE DRAWINGS

Through the following detailed description of the example embodiments of the disclosure with reference to the accompanying drawings, the above and other objectives, features, and advantages of the disclosure will become more apparent. Throughout the accompanying drawings, like or similar reference numerals represent same or identical elements. It is understood that the drawings are schematic, so that the components and elements are not drawn with exact scales.

FIG. 1 is a flow diagram of an information processing method according to embodiments of the disclosure.

FIG. 2 is a structural diagram of an electronic device according to embodiments of the disclosure.

### DETAILED DESCRIPTION OF EMBODIMENTS

Hereinafter, embodiments of the disclosure will be described in more detail with reference to the accompanying drawings. Although some example embodiments of the disclosure have been illustrated in the drawings, it is understood that the disclosure may be implemented in various forms, not limited to the example embodiments depicted herein; instead, provision of these example embodiments is intended for a more thorough and comprehensive understanding of the disclosure. It is understood that the accompanying drawings and example embodiments provided herein are only for illustrative purposes, not for limiting the scope of protection of the disclosure.

It is understood that the various steps recited in method embodiments of the disclosure may be performed sequentially and/or concurrently. In addition, the method embodiments may comprise additional steps and/or omit some steps illustrated. The scope of the disclosure is not limited thereto.

The term “comprise” and its variants used herein refer to an open inclusion, i.e., “including, but not limited to.” The term “based on” refers to “at least partially based on.” The term “one embodiment” refers to “at least one embodiment”; the term “another embodiment” refers to “at least one further embodiment”; and the term “some embodiment” refers to “at least some embodiments.” Relevant definitions of other terms will be provided in the description infra.

It is noted that concepts such as “first” and “second” indicated herein are used only for distinguishing different apparatuses, modules, or units, not intended for limiting the sequence of the functions executed by such apparatuses, modules or units or limiting their mutual dependencies.

It is noted that the modifier “a/an” indicated herein is illustrative, not limitative. Those skilled in the art would understand that except otherwise indicated in the context, this modifier shall be understood as “one or more.” The term “A and/or B” indicated herein represent three parallel circumstances: A; B; and A and B, i.e., at least one of A and B.

The names of interactive messages or information between a plurality of apparatuses in the embodiments of the disclosure are only for illustrative purposes, not for limiting the scope of such messages or information.

Hereinafter, the solutions provided in the embodiments of the disclosure will be described in detail.

In a scenario of collaborative processing for a project, information synchronization, i.e., forwarding a message in one communication group to another communication group, always occurs between different communication groups, which is conventionally done manually and thusly tedious. Therefore, in some technologies, a message publisher would join all communication groups and directly send messages to all groups via a message sending interface, or create a group list and send the message uniformly to all heads of the communication groups via a message interface of a server to inform the group heads to send the message to their respective groups. The two approaches noted supra require manual maintenance of a group list and require the publisher to join all chat groups, so that they are demanding on the publisher, and sometimes permission issues may occur.

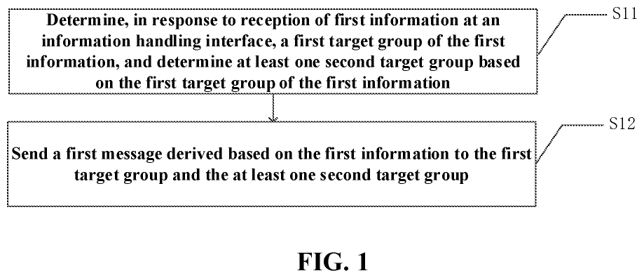

FIG. 1 illustrates a flow diagram of an information processing method according to embodiments of the disclosure, comprising steps of:
S11: In response to reception of first information at an information processing interface, a first target group of the first information is determined, and at least one second target group is determined based on the first target group of the first information.
S12: A first message derived based on the first information is sent to the first target group and the at least one second target group.

In some embodiments, the information processing interface is an interface other than a communication interface of the first target group and a communication interface of the second target group. In some embodiments, the first information may be input in a mini program; the mini program may be a mini program in an IM client; in some other embodiments, the information processing interface may be an input interface of a data system other than an instant messaging system, so that the first information is inputted in the data system, and then the data system sends the first message to the first target group and the second target group. The first message may include the first information. In some embodiments, the first information may be information associated with the project, and the first information may include an information type; the information type of the first information may, for example, be a project tracking record, a project demand record, a project weekly report, or a project daily report. The first target group of the first information may be a group specified by a current user who inputs the first information, or may be a group determined based on the information type of the first information. The second target group is determined based on the first target group, which may be a group associated with the first target group. For example, the first target group may be a project general group of an internal project, while the second target group may be a manager group of the internal project. Since the managers in the manager group should track the project progress, the information sent to the project general group should be sent to the manager group. Since the second target group is determined based on the first target group, a need of manually specifying the second target group is eliminated; and since the information input interface is an interface other than the communication interfaces of the first and second target groups, the user needn't join the first target group or the second target group, which facilitates information sending and significantly enhances collaboration efficiency across the organization.

In some embodiments of the disclosure, the first information is information of a target object; the determining at least one second target group based on the first target group of the first information comprises: determining at least one object-associated group which is associated with the first target group via the target object; and the at least one second target group includes a group in the at least one object-associated group.

In some embodiments, the target object may refer to an internal project, and the first information may refer to progress tracking information of the internal project. In some embodiments, one group may be associated with another group via the object. For example, it is supposed that one group is a general group of Project 1 and another group is the manager group of Project 1, then the two groups may be associated via Project 1. Therefore, at least one object-associated group which is associated with the first target group via the target object may be determined based on the first target group, so that the first message is sent to the at least one object-associated group. The at least one second target group may include all object-associated groups or may include a part of the object-associated groups, in which case, the first message may be sent to only the part of object-associated groups.

In some embodiments of the disclosure, the at least one second target group includes: a group which is associated with the first target group via the target object and associated with other groups via other objects. In some embodiments, at least one group in the object-associated groups may be simultaneously associated with at least two groups via objects, in which case, messages in the associated at least two groups may all be sent to the object-associated group. For example, Group 1 is associated with Group 2 via Object 1, and Group 1 is further associated with Group 3 via Object 2. In this case, when the first target group is Group 2 or Group 3, the first message would be sent to Group 1 as well, so that messages in Group 2 and Group 3 may be received by Group 1. In this way, messages in a plurality of groups may be converged in one group. An example actual scenario is that Group 1 is a manager group, and Group 2 and Group 3 are general groups for different projects.

In some embodiments of the disclosure, the first information is information of the target object, and the at least one object-associated group which is associated with the target group via the target object is configured with a first preset condition; the determining at least one second target group based on the first target group of the first information comprises: determining at least one object-associated group which is associated with the first target group via the target object, and determining, from the at least one object-associated group, at least one condition-associated group configured with the first preset condition with the first information satisfying the first preset condition; and the at least one second target group includes the at least one condition-associated group.

In some embodiments, the condition-associated group is an object-associated group configured with the first preset condition, and part or all of the groups in the object-associated groups associated with the first target group via the target object are configured with the first preset condition. In this case, whether to send the first message to the condition-associated group is determined based on the first preset condition. The first preset conditions configured for different condition-associated groups may be identical or different, and the first information may be matched with the first preset condition of respective condition-associated groups, respectively, so as to determine at least one condition-associated group with the first information satisfying the configured first preset condition, and then the first message may be sent to the at least one condition-associated group. In some embodiments, information may be filtered by setting the first preset condition. The first preset condition may include, for example, the type of the first information being a specified type, the sender of the first information being a specified user, etc. The content of the first preset condition may be set by the group configured with the first preset condition or may be set by the first target group.

In some embodiments of the disclosure, the determining at least one second target group based on the first target group of the first information comprises: in a case that the first target group of the first information is a general group having sub-groups, the second target group excludes the sub-groups; in a case that the first target group of the first information is a sub-group of a general group, the at least one second target group includes the general group. In some embodiments, groups may include the general group and the sub-group. One general group is associated with one or more sub-groups. In a case that the first target group is a general group having sub-groups, the second target group excludes the sub-groups of the general group, which may prevent a message in the general group from being synchronized to the sub-group; while in a case that the first target group is a sub-group, the second target group includes the general group of the sub-group. In this embodiment, a message sent to the general group will not be sent to the sub-group, while a message sent to the sub-group may be sent to the general group, whereby unidirectional message flow may be realized. In some embodiments, members of the sub-group may be a subset of the members of the general group. For example, supposing Sub-group 1 and Sub-group 2 are set up by part of the members of the project general group, if the first target group is Sub-group 1 or Sub-group 2, the first message will also be sent to the general group of the sub-group, i.e., the project general group. In this way, the message of the sub-group is sent to the general group, ensuring that other members in the general group can access the latest message timely. While in a case that the first target group is the general group, the first message will not be sent to the sub-group, preventing the members in the sub-group from repetitively viewing the first message.

In some embodiments of the disclosure, the determining at least one second target group based on the first target group of the first information comprises: determining, based on a subscription relationship of the first target group, at least one first subscribing group having subscribed to the first target group, the at least one second target group including groups in the at least one first subscribing group.

In some embodiments of the disclosure, a group is subscribable. After one group subscribes to another group, a subscription relationship is established therebetween, so that a message in the first target group may be sent to groups having subscribed to the first target group. Therefore, after the at least one first subscribing group having subscribed to the first target group has been determined based on the first target group, the first message may be sent to all first subscribing groups. In some embodiments, a subscription condition may be set for the first target group and only eligible groups may subscribe to the first target group. In this way, subscription to the first target group by an undesired group may be avoided.

In some embodiments of the disclosure, the determining at least one second target group based on the first target group of the first information comprises: determining, based on a subscription relationship of the first target group, at least one second subscribing group having subscribed to messages satisfying a second preset condition in the first target group, the at least one second target group including groups in the at least one second subscribing group.

In some embodiments, one group may intend to only subscribe to specific messages in another group, or only a part of messages in one group can be sent to the group subscribing to the one group. Therefore, in some embodiments, a second preset condition is set. In this case, it may be first determined whether the first information satisfies the second preset condition. If the first information satisfies the second preset condition, then at least one second subscribing group having subscribed to messages satisfying the second preset condition in the first target group is determined, and the first message is sent to the second subscribing group. In some embodiments, by setting the second preset condition, it may be avoided that all messages in the first target group are sent to the group having subscribed to the first target group, and by filtering the messages, it may be avoided to send invalid messages, thereby reducing disturbance to members in the second subscribing group.

In some embodiments, the second preset condition is set in the first target group. In some embodiments, the subscribed first target group may set the second preset condition and may configure second preset conditions for respective groups having subscribed to the first target group, respectively, and the second preset conditions configured for respective groups are independent to each other, which may be identical or different. In this way, it may be set in the first target group which information may be sent to which group, thereby realizing synchronization of individualized information for different groups.

In some other embodiments, the second preset condition is set in the second subscribing group. In some embodiments, the second subscribing group having subscribed to the first target group may set which messages in the first target group it intends to subscribe to. In some embodiments, the second preset conditions in different second subscribing groups are independent to each other, which may be identical or different. By setting the configured second preset condition in the second subscribing group, the second subscribing group having subscribed to the first target group can actively define which messages to receive, thereby realizing individualized message reception.

In some embodiments of the disclosure, the first message includes an entry control for joining the first target group. In some embodiments of the disclosure, the first message includes an entry control so that a member in the second target group may join the first target group by triggering the first message sent to the second target group, which facilitates the member in the second target group to join the first target group for further discussion in a case of feeling interested in the first message. In some embodiments, the first message may be displayed in a form of message card, where the entry control may be displayed in the message card. The entry control for example may be a “Join Group” button, so that members in the second target group may click the button to join the first target group. In some embodiments, the entry control in the first message may not be displayed in the first target group, avoiding a poor experience of a member in the first target group who clicks the entry control but fails to join the corresponding group.

In some embodiments of the disclosure, the method is performed by a chatbot having joined each group. In some embodiments, the chatbot is a member of the groups. With the chatbot performing the method provided in the embodiments of the disclosure, a need is eliminated for a user who sends the first information to join respective groups. The user might have no permission to join some groups thereof, so that with the chatbot performing the method in the embodiments, the potential restricted permission issue caused by having to join a group before sending a message to the group might be overcome.

In some embodiments of the disclosure, if a current user who creates the first information has joined the first target group, the first message is sent via the account of the current user in the first target group; otherwise, the first message is sent via the chatbot in the first target group, with user identifier of the current user being displayed. In some example embodiments, if the current user has joined the second target group, the first message is sent via the account of the current user in the second target group; otherwise, the first message is sent via the chatbot in the second target group, with the user identifier of the current user being displayed.

In some embodiments, if the current user has joined a group to which the first message is sent, the first message is sent via the account of the current user; otherwise, the first message is sent via the chatbot in the group, with the user identifier being displayed. This may facilitate a group member receiving the first message to know who sends the first message, so that the group member, if being interested in the first message, may contact the sender, and may know whether the user sending the first message is a member of the group depending on the sender of the first message. In some embodiments, a contact identifier of the current user is displayed in the first message, so that communication contact with the current user may be established upon the contact identifier being triggered, e.g., an “Add Friend” button may be displayed in the first message, so that a communication relationship with the current user may be established via the first message.

In some embodiments, the first message is sent via a chatbot in the first target group and the second target group, with the user identifier of the current user being displayed. In some embodiments, the first message may be sent via the chatbots in all groups receiving the first message; however, at this point, the user identifier of the current user is still displayed, thereby facilitating knowledge of who sends the first message.

In some embodiments of the disclosure, the first information is first information of the target object; the information input interface comprises: an information input interface of the target object displayed in a mini program; in some embodiments, the mini program may be a module in an application, e.g., a mini-program module in an IM (Instant Messaging) client; the information input interface is an information input interface of the target object, which may be used to input information associated with the target object, so that after inputting the first information associated with the target object, the user may send the first message to the first target group or the second target group, without a need for an extra operation of sending the first message after inputting the first information of the target object, which eliminates the user's operation steps and improves use experience of the user.

In one embodiment of the disclosure, in a case that the information input interface is an information input interface of the target object displayed in the mini program, the mini program performs the steps of determining, in response to reception of the first information at the information processing interface, the first target group of the first information, and determining at least one second target group based on the first target group of the first information, and the mini program sends, via the chatbot, the first message derived based on the first information to the first target group and the at least one second target group.

In some embodiments of the disclosure, the information input interface comprises: an information input interface of the target object in a data system. In some embodiments, the data system for example may be a data system in a server; the data system may be a system for storing association information of the target object, and in the data system, the first information may be directly inputted and the first message may be sent to the first target group and the second target group.

In one embodiment of the disclosure, in a case that the information input interface is an information input interface of the target object in the data system, a predetermined module in the data system performs the steps of determining, in response to reception of the first information at the information processing interface, the first target group of the first information, and determining at least one second target group based on the first target group of the first information, and the predetermined module sends, via a chatbot, the first message derived based on the first information to the first target group and the at least one second target group. In this case, the predetermined module pre-establishes a communication interface with the chatbot in an IM (Instant Messaging) system.

In some embodiments of the disclosure, the first target group is a group bound with the information processing interface. In some embodiments, the first target group may also be determined based on the information processing interface; different information processing interfaces are independently associated with groups; the groups associated with different information processing interfaces may be identical or different, so that the user may automatically determine the first target group by invoking different information processing interfaces, without a need to manually specify the first target group.

In some embodiments of the disclosure, the first target group is a group bound with the type of the first information. In some embodiments, the first target group may also be a communication group determined based on the type of the first information, so that upon the first information being inputted, the first target group may be automatically determined, without a need for the user to manually specify the first target group. For example, in a case that the method provided according to the embodiments of the disclosure is applied to an internal project, it may be set that the project tracking information is bound with the project tracking group and the project tracking group is bound with the project general group. In this way, when the user inputs the first information and the type of the first information is the project tracking information, the first target group is determined as the project tracking group, and the project general group as the second target group is determined based on the project tracking group, so that the first message is sent to the project tracking group and the project general group, which eliminates a need for the user to specify a group to be sent and a need for sending the first message at the communication interfaces of the project tracking group and the project general group, thereby reducing user operation and avoiding the permission issue by not requiring the user to join various groups.

In some embodiments of the disclosure, members of a member-associated group include an associated member. In a case that the first information is information created by the associated member, the first message is also sent to the member-associated group; or, in a case that the first information is a second type of information created by the associated member, the first message is also sent to the member-associated group. In some embodiments, for example, members in the member-associated group may be managers of some sub-projects of an internal project, and an associated member may be a concerned operational individual of a sub-project. After the concerned operational individual sends the first information, since the head of the sub-project needs to view the information sent by the operational individual, the first message will be sent to the member-associated group where the manager of the sub-project is included; and one member in the member-associated group may have a plurality of associated members.

In some example embodiments of the disclosure, the first information is information of a target object, the target object having a corresponding tag, a tag-associated group being associated with a first tag; in a case that a tag of the target object includes the first tag, the first message is also sent to the tag-associated group. In some embodiments, the tag-associated group has an associated tag; if the target object also has the same tag, the first message is sent to the tag-associated group. For example, the object may be an internal project, and the tag for example may be a name of a person, e.g., Zhang San; if Zhang San is in charge of a plurality of internal projects, the internal projects in the charge of Zhang San may be tagged with “Zhang San”; the tag-associated group may be a group for the projects in the charge of Zhang San and may also be associated with the tag “Zhang San” so that the information of the object associated with the tag “Zhang San” is sent to the tag-associated group so as to facilitate Zhang San to know the progress of the internal projects in his charge.

In some embodiments of the disclosure, in response to setting a level for the first information at the information processing interface, a first flag corresponding to the level of the first information is displayed in the first message. In some embodiments, the level may include importance and non-importance, so that the user may determine an importance level of the message by viewing the first message.

In some embodiments of the disclosure, in response to setting a class for the target object at the information processing interface, a second flag corresponding to the class of the target object is displayed in the first message. In some embodiments, the class for example may include whether the target object is an object that needs help or an object that does not need help. For example, if the object is a project, the class may be whether the project needs additional personnel to help or does not need additional personnel to help.

In some embodiments of the disclosure, in response to the first information being a first preset type of information of the target object, a third flag is displayed in the first message. In some embodiments, for a preset type of information sent for the first time, since the same type of information is absent, the third flag is displayed, indicating that this type of information is sent for the first time, avoiding an issue that the user browses through historical records for the same type of information but finds nothing.

In some embodiments of the disclosure, there is further provided an information processing method, comprising:
determining, in response to receiving first information at a communication interface of a first group, a target identifier bound with the first group and a set of groups bound with the target identifier;
determining at least one second group based on an association relationship between the first group and respective groups in the set of groups;
sending a first message derived based on the first information to the first group and the at least one second group.

In some embodiments of the disclosure, upon receiving the first information at the communication interface of the first group, the target identifier and the set of groups bound with the target identifier are determined, and then one or more second groups having an association relationship with the first group are determined from the set of groups, so that the first message is sent to the first group and the at least one second group, whereby multi-group messaging is enabled, which eliminates a need for the user to manually send the first message to the second group or a need of joining the second group. Moreover, it is noted that since the set of groups is bound with the target identifier, the groups in the set of groups are all associated with the target identifier, where the target identifier may be an identifier of the target object. In this embodiment, by associating the groups in the set of groups via the target identifier, the groups are closely associated with each other, which can ensure that the second group and the first group are not only mutually associated, but also closely associated via the target identifier, i.e., in the embodiments of the disclosure, it is not the case that so long as the second group is associated with the first group, the first message would be sent to the first group and the second group; instead, the first message is sent to the first group and the second group only in the case that the second group and the first group are associated via the target identifier. Since the associated first group and second group are bound with the same target identifier, the groups (the first group and the second group) for message synchronization are more closely associated therebetween, so that the synchronized message is more accurate.

For example, Group a and Group b are both groups associated with Project A, and Group c is also associated with Group a; but Group c and Group a are not associated via Project A. When Message x is sent in Group a, the Message x will be synchronized to Group b without being synchronized to Group c according to the solution of this embodiment.

In some embodiments of the disclosure, the at least one second group is determined based on the association relationship between the first group and respective groups in the set of groups, where the set of groups include a general group and at least one sub-group; in a case that the first group is the general group, the at least one second group excludes the sub-groups of the general group; and in a case that the first group is a sub-group, the at least one second group includes the general group of the sub-group. In some embodiments, a group may include a general group and a sub-group, one general group being associated with one or more sub-groups; in a case that the first target group is a general group having sub-groups, the second group excludes the sub-groups of the general group, which may prevent synchronizing a message in the general group to the sub-group; while in a case that the first target group is a sub-group, the second target group includes the general group of the sub-group. In this embodiment, the message sent to the general group will not be sent to the sub-group, while the message sent to the sub-group will be sent to the general group, so that unidirectional flow of the message is realized. In some embodiments, members of the sub-group are in a subset of members of the general group.

In some other embodiments of the disclosure, members of the general group and members of the sub-group have an intersection, i.e., the members of the general group and those of the sub-group partially overlap. In some other embodiments, the members of the general group and the members of the sub-group are not intersected, i.e., the members of the general group are totally different from those of the sub-group. In the two cases, the general group and the sub-group may be distinguished by setting a group tag, or the general group and the sub-group may be determined by the manner of group creation. For example, a group created on the first type of page is referred to as the general group, and a group created on the second type of page is referred to as the sub-group.

In some embodiments of the disclosure, the determining at least one second group based on an association relationship between the first group and respective groups in the set of groups comprises: determining, based on a subscription relationship of the first group, at least one first subscribing group having subscribed to the first group from among the set of groups; and the at least one second group comprises a group in the at least one first subscribing group. In some embodiments, the groups are subscribable, and after one group has subscribed to another group, the two groups have a subscription relationship, so that a message in the first group may be sent to the group having subscribed to the first group. Therefore, after determining at least one first subscribing group having subscribed to the first target group based on the first group, the first message may be sent to all first subscribing groups. In some embodiments, a subscription condition may be set for the first group, and only a group satisfying the subscription condition may subscribe to the first group, so that the first group may be prevented from being subscribed to by specific undesired groups.

In some embodiments of the disclosure, based on the subscription relationship of the first group, at least one first subscribing group having subscribed to the first group is determined from among the set of groups, and at least one second subscribing group is determined from among the at least one first subscribing group, the second subscribing group being configured with a preset information synchronization condition, and the first information satisfying the preset information synchronization condition; and the at least one second group comprises groups in the at least one second subscribing group.

In some embodiments, one group may only intend to subscribe to specific messages in another group; or, only a part of messages in one group can be sent to groups having subscribed to the group. Therefore, in some embodiments, an information synchronization condition is set. By setting the information synchronization condition, it may be avoided that all messages in the first group are sent to groups having subscribed to the first group. By filtering messages, it may be avoided to send invalid messages, reducing disturbance with the members in the second subscribing group. In some embodiments, the information synchronization condition is set in the first group; or, the information synchronization condition is set in the second subscribing group.

In some embodiments of the disclosure, the first message includes an entry control for joining the first group. In some embodiments, the method is executed by a chatbot joining the set of groups bound with the target identifier.

In some embodiments of the disclosure, if the current user creating the first information has joined the first group, the first message is sent via an account of the current user in the first group; otherwise, the first message is sent via the chatbot in the first group with user identifier of the current user being displayed; and/or, if the current user has joined the second group, the first message is sent via the account of the current user in the second group; otherwise, the first message is sent via the chatbot in the second group with the user identifier of the current user being displayed.

In some embodiments of the disclosure, in the first group and the second group, the first message is sent via the chatbot, with the user identifier of the current user being displayed.

In some embodiments of the disclosure, there is further provided an information processing apparatus, comprising:
a first determining unit configured to determine, in response to reception of first information at an information processing interface, a first target group of the first information, and determine at least one second target group based on the first target group of the first information;
a first sending unit configured to send a first message derived based on the first information to the first target group and the second target group, wherein the information processing interface is an interface other than a communication interface of the first target group and a communication interface of the second target group.

In some embodiments of the disclosure, the first information is information of a target object;
determining, by the first determining unit, at least one second target group based on the first target group of the first information comprises: determining at least one object-associated group associated with the first target group via the target object, the at least one second target group including a group in the at least one object-associated group.

In some embodiments of the disclosure, the at least one second target group includes: a group associated with the first target group via the target object and associated with another group via another object.

In some embodiments of the disclosure, the first information is information of the target object, and at least one object-associated group associated with the first target group via the target object is configured with a first preset condition;
determining, by the first determining unit, at least one second target group based on the first target group of the first information comprises: determining at least one object-associated group associated with the first target group via the target object, and determining, from among the at least one object-associated group, at least one condition-associated group configured with the first preset condition with the first information satisfying the first preset condition, the at least one second target group including the at least one condition-associated group.

In some embodiments of the disclosure, determining, by the first determining unit, at least one second target group based on the first target group of the first information is carried out in such a manner that:
in a case that the first target group of the first information is a general group having sub-groups, the second target group excludes the sub-groups; and in a case that the first target group of the first information is a sub-group of the general group, the at least one second target group includes the general group.

In some embodiments of the disclosure, determining, by the first determining unit, at least one second target group based on the first target group of the first information comprises:
determining at least one first subscribing group having subscribed to the first target group based on a subscription relationship of the first target group, the at least one second target group including groups in the at least one first subscribing group.

In some embodiments of the disclosure, determining, by the first determining unit, at least one second target group based on the first target group of the first information comprises: determining, based on the subscription relationship of the first target group, at least one second subscribing group having subscribed to messages satisfying a second preset condition in the first target group, the at least one second target group including a group in the at least one second subscribing group, and the first information satisfying the second preset condition.

In some embodiments of the disclosure, the second preset condition is set in the first target group; or, the second preset condition is set in the second subscribing group.

In some embodiments of the disclosure, the first message comprises an entry control for joining the first target group.

In some embodiments of the disclosure, a control device is configured to control a chatbot joining each group.

In some embodiments of the disclosure, in a case that a current user creating the first information has joined the first target group, the first sending unit is configured to send the first message via an account of the current user in the first target group; otherwise, the first message is sent via the chatbot in the first target group, with user identifier of the current user being displayed. In some embodiments, in a case that the current user has joined the second target group, the first sending unit is configured to send the first message via the account of the current user in the second target group; otherwise, the first message is sent via the chatbot in the second target group, with the user identifier of the current user being displayed.

In some embodiments, the first sending unit is configured to send the first message via the chatbot in the first target group and the second target group, with the user identifier of the current user being displayed.

In some embodiments of the disclosure, the first information is first information of the target object; and the information input interface comprises: an information input interface of the target object displayed in a mini program; or, an information input interface of the target object in the data system.

In some embodiments of the disclosure, the first target group is a group bound with the information processing interface; or, the first target group is a group bound with a type of the first information.

In some embodiments of the disclosure, there is provided an information processing apparatus, comprising:
a second determining unit configured to determine, in response to receiving first information at a communication interface of a first group, a target identifier bound with the first group and a set of groups bound with the target identifier, and determine at least one second group based on an association relationship between the first group and respective groups in the set of groups;
a second sending unit configured to send a first message derived based on the first information to the first group and the at least one second group.

In some embodiments of the disclosure, determining, by the second determining unit, at least one second group based on an association relationship between the first group and respective groups in the set of groups, is carried out in such a manner that the set of groups include a general group and at least one sub-group; in a case that the first group is a general group, the at least one second group excludes sub-groups of the general group; and in a case that the first group is a sub-group, the at least one second group includes the general group of the sub-group.

In some embodiments of the disclosure, determining, by the second determining unit, at least one second group based on an association relationship between the first group and respective groups in the set of groups comprises: determining, based on a subscription relationship of the first group, at least one first subscribing group having subscribed to the first group from among the set of groups, the at least one second group including groups in the at least one first subscribing group.

In some embodiments of the disclosure, the second determining unit determines, based on the subscription relationship of the first group, at least one first subscribing group having subscribed to the first group from among the set of groups, and determines at least one second subscribing group from among the at least one first subscribing group, the second subscribing group being configured with a preset information synchronization condition, the first information satisfying the preset information synchronization condition, and the at least one second group including groups in the at least one second subscribing group.

In some embodiments of the disclosure, the first message includes an entry control for joining the first group. In some embodiments, a control device controls a chatbot joining the set of groups bound with the target identifier to carry out various steps.

In some embodiments of the disclosure, in a case that a current user creating the first information has joined the first group, the second sending unit sends the first message via an account of the current user in the first group, and otherwise sends the first message via the chatbot in the first group, with the user identifier of the current user being displayed; and/or, in a case that the current user has joined the second group, the second sending unit sends the first message via the account of the current user in the second group, and otherwise sends the first message via the chatbot in the second group, with the user identifier of the current user being displayed.

In some embodiments of the disclosure, the second sending unit sends the first message via the chatbot in the first group and the second group, with the user identifier of the current user being displayed.

Since the apparatus embodiments substantially correspond to method embodiments, relevant features of the apparatus embodiments may refer to the depictions of method embodiments. The apparatus embodiments described herein are only schematic, and those modules illustrated as discrete modules may be or may not be separate. Some or all of the modules may be selected to implement the solutions of the embodiments of the disclosure dependent on actual needs. A person of normal skill in the art may understand and implement the apparatus embodiments without exercise of inventive work.

The method and apparatus of the disclosure have been illustrated above via embodiments and application examples. In addition, the disclosure further provides a terminal and a storage medium, which will be described infra.

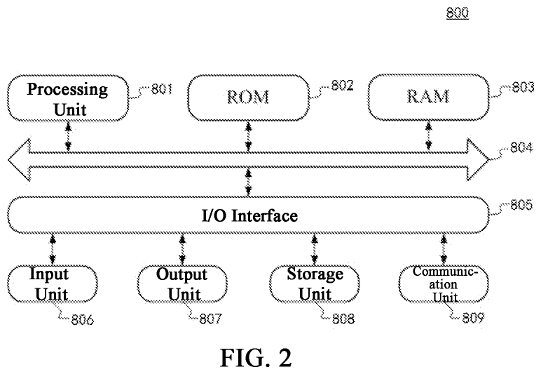

FIG. 2 illustrates a structural schematic diagram of an electronic device 800 (the electronic device for example may be a terminal device or a server, where the terminal device may also be referred to as a terminal) adapted to implement the embodiments of the disclosure. The terminal device referred to in the embodiments of the disclosure may include, but is not limited to, a mobile terminal such as a mobile phone, a laptop device, a digital broadcast receiver, a PDA (Personal Digital Assistant), a PAD (Tablet), a PMP (Portable Media Player), or a vehicle-mounted terminal (e.g., a vehicle-mounted navigation terminal), and a fixed terminal such as a digital TV or a table computer. The electronic device illustrated herein is only exemplary, which should not constitute any limitation to the functions and scope of use of the embodiments of the disclosure.

The electronic device 800 may comprise a processing unit (e.g., a Center Processing Unit, a Graphic Processing Unit, etc.) 801, which may execute various suitable actions and processing based on the program stored in a read-only memory (ROM) 802 or a program loaded in the random-access memory (RAM) 803 from a storage unit 808. The RAM 803 can also store all kinds of programs and data necessary to operation of the electronic device 800. The processing device 801, ROM 802 and RAM 803 are interconnected to each other via a bus 804. The input/output (I/O) interface 805 is also connected to the bus 804.

Generally, the following devices may be connected to the I/O interface 805: an input unit 806 including, e.g., a touch screen, a touch pad, a keypad, a mouse, a camera, a microphone, an accelerometer, or a gyroscope; an output unit 807, e.g., a LCD (Liquid Crystal Display), a loudspeaker, or a vibrator; a storage unit 808 such as a magnetic tape, a hard disk; and a communication unit 809. The communication unit 809 allows the electronic device 800 to exchange information/data with other devices via wireless or cable communication. Although the electronic device 800 comprising various components is shown in the figure, it is understood that it is not required to implement or possess all of the illustrated components. Alternatively, more or less components may be implemented or possessed.

Particularly, according to the embodiments of the disclosure, the processes described with reference to the above flow diagram may be implemented as computer software programs. For example, embodiments of the disclosure comprise a computer program product comprising a computer program carried on the computer-readable medium, the computer program including program codes for performing the methods illustrated in the flow diagram. In such embodiments, the computer program may be downloaded and installed from the network via the communication unit 809, or installed from the storage unit 808, or installed from the ROM 802. When the computer program is executed by the processing unit 801, the actions defined by the methods according to the embodiments of the disclosure are implemented.

It is noted that, the computer-readable medium described supra may be a computer-readable signal medium or a computer-readable storage medium or any combination of the above. The computer-readable storage medium for example may be, but is not limited to, electric, magnetic, optical, electro-magnetic, infrared or semiconductor system, apparatus or device, or any combination thereof. More specific examples of the computer-readable storage medium include, but are not limited to, an electric connection via one or more wires, a portable computer magnetic disk, hard disk, random access memory (RAM), read-only memory (ROM), erasable programmable read-only memory (EPROM or flash memory), optical fiber, portable compact-disc read-only storage medium (CD-ROM), optical storage device, magnetic storage device, or any appropriate combination thereof. In the disclosure, the computer-readable storage medium may refer to any tangible medium including or storing a program that can be used by an instruction executing system, apparatus or device or used by a combination thereof. However, in the disclosure, the computer-readable signal medium may include data signals in the base band or propagated as a part of carrier, in which the computer-readable program codes are carried. This propagated data signals may take on various forms, including, but not limited to, electromagnetic signals, optical signals, or any suitable combination thereof. The computer-readable signal medium may also be any computer-readable medium other than the computer-readable storage medium, which computer-readable signal medium may transmit, propagate, or transfer a program used by the instruction executing system, apparatus or device, or used in combination therewith. The program code stored on the computer-readable medium may be transmitted via any appropriate medium including, but is not limited to, wires, cables, RFs (Radio Frequencies), etc., or any appropriate combination thereof.

In some embodiments, the client and the server may communicate using any currently known or future developed network protocols such as HTTP (HyperText Transfer Protocol), and may be interconnected with a digital data communication (e.g., communication network) of any form or medium. Examples of the communication network include a local area network (“LAN”), a wide area network (“WAN”), a network of networks (e.g., the Internet), and a peer-to-peer network (e.g., an ad hoc peer-to-peer network), and any currently known or future developed network.

The computer-readable medium may be included in the electronic device, or may be standalone, without being installed in the electronic device.

The computer-readable medium carries one or more programs; when the one or more programs are executed by the electronic device, the electronic device performs the methods of the disclosure.

The computer-program code for performing the operations of the disclosure may be compiled with one or more programming languages or a combination thereof; the programming languages comprise object-oriented programming languages, e.g., Java, Smalltalk, C++, and further comprise traditional procedural programming languages, such as “C” language or similar programming languages. The program codes can be executed completely on the user computer, partially on the user computer, as an independent software package, partially on the user computer and partially on the remote computer, or completely on the remote computer or server. In a scenario where a remote computer is involved, the remote computer can be connected to the user computer via any type of network, including local area network (LAN) and wide area network (WAN), or to the external computer (e.g., connected via Internet using the Internet service provider).

The flow diagrams and block diagrams in the drawings illustrate system architecture, functions and operations that may be implemented by the system, method and computer program product according to various embodiments of the disclosure. In this regard, each block in the flow diagram or block diagram can represent a module, a program snippet, or a part of code, wherein the module, the program snippet, or the part of code includes one or more executable instructions for performing specified logic functions. It is also noted that, in some alternative implementations, the functions indicated in the blocks can also occur in an order different from those indicated in the drawings. For example, two successively represented blocks can be actually executed in parallel and sometimes in a reverse order dependent on the concerned functions. It is also noted that, each block in the block diagram and/or flow diagram and a combination of the blocks in the block diagram and/or flow diagram may be implemented by a dedicated hardware-based system for executing specified functions or actions, or implemented by a combination of dedicated hardware and computer instructions.

The units described in the embodiments of the disclosure may be implemented in a software manner or in a hardware manner, wherein the names of the units do not constitute limitation to the unit per se in some circumstances.

The functions described herein may be executed at least partially by one or more hardware logic components. For example, an example hardware logic component that may be used includes, but is not limited to, a field programmable gate array (FPGA), an application-specific integrated circuit (ASIC), an application-specific standard product (ASSP), a system-on-chip (SOC), and a complex programmable logic device (CPLD), etc.

Within the context of the present disclosure, the machine-readable medium may be any tangible medium including or storing programs for or related to the instruction execution system, apparatus, or device. The machine readable medium may include, but is not limited to, electronic, magnetic, optical, electro-magnetic, infrared or semiconductor system, apparatus or device, or any combination thereof. More specific examples of the machine-readable storage medium include an electric connection via one or more wires, a portable computer magnetic disk, a hard disk, a random access memory (RAM), a read-only memory (ROM), an erasable programmable read-only memory (EPROM or flash memory), an optical storage device, a magnetic storage device, or any appropriate combination thereof.

According to one or more embodiments of the disclosure, [example 1] provides an information processing method, comprising:
determining, in response to reception of first information at an information processing interface, a first target group of the first information, and determining at least one second target group based on the first target group of the first information; and
sending a first message derived based on the first information to the first target group and the at least one second target group; wherein the information processing interface is an interface other than a communication interface of the first target group and a communication interface of the second target group.

According to one or more embodiments of the disclosure, [example 2] provides the method of [example 1], in which
the first information is information of a target object; and
the determining at least one second target group based on the first target group of the first information comprises: determining at least one object-associated group which is associated with the first target group via the target object, the at least one second target group including groups in the at least one object-associated group.

According to one or more embodiments of the disclosure, [example 3] provides the method of [example 2], in which the at least one second target group comprises a group associated with the first target group via the target object and associated with other groups via other objects.

According to one or more embodiments of the disclosure, [example 4] provides the method of [example 1], in which the first information is information of a target object, and at least one object-associated group which is associated with the first target group via the target object is configured with a first preset condition; and the determining at least one second target group based on the first target group of the first information comprises: determining the at least one object-associated group which is associated with the first target group via the target object, and determining, from among the at least one object-associated group, at least one condition-associated group configured with the first preset condition with the first information satisfying the first preset condition, the at least one second target group including the at least one condition-associated group.

According to one or more embodiments of the disclosure, [example 5] provides the method of [example 1], in which the determining at least one second target group based on the first target group of the first information is carried out in such a manner that
in a case that the first target group of the first information is a general group having sub-groups, the second target group does not include the sub-groups; or,
in a case that the first target group of the first information is a sub-group of a general group, the at least one second target group includes the general group.

According to one or more embodiments of the disclosure, [example 6] provides the method of [example 1], in which the determining at least one second target group based on the first target group of the first information comprises:
determining at least one first subscribing group having subscribed to the first target group based on a subscription relationship of the first target group, the at least one second target group including groups in the at least one first subscribing group.

According to one or more embodiments of the disclosure, [example 7] provides the method of [example 1], in which the determining at least one second target group based on the first target group of the first information comprises: determining, based on a subscription relationship of the first target group, at least one second subscribing group having subscribed to a message satisfying a second preset condition in the first target group, the at least one second target group including groups in the at least one second subscribing group, and the first information satisfying the second preset condition.

According to one or more embodiments of the disclosure, [example 8] provides the method of [example 7], in which the second preset condition is set in the first target group; or, the second preset condition is set in the second subscribing group.

According to one or more embodiments of the disclosure, [example 9] provides the method of [example 1], in which the first message includes an entry control for joining the first target group.

According to one or more embodiments of the disclosure, [example 10] provides the method of [example 1], in which in a case that a current user creating the first information has joined the first target group, the first message is sent in the first target group via an account of the current user; otherwise, the first message is sent in the first target group via a chatbot, with the user identifier of the current user being displayed; and/or, in a case that the current user has joined the second target group, the first message is sent in the second target group via the account of the current user; otherwise, the first message is sent in the second target group via the chatbot, with the user identifier of the current user being displayed;
or, the first message is sent in the first target group and the second target group via the chatbot, with the user identifier of the current user being displayed.

According to one or more embodiments of the disclosure, [example 11] provides the method of [example 1], in which the first information is first information of a target object; the information input interface includes an information input interface of the target object displayed in a mini program; or an information input interface of the target object in a data system.

According to one or more embodiments of the disclosure, [example 12] provides the method of [example 11], in which
in a case that the information input interface is the information input interface of the target object displayed in the mini program, the mini program performs the determining, in response to reception of first information at an information processing interface, a first target group of the first information, and determining at least one second target group based on the first target group of the first information, and the mini program sends the first message derived based on the first information to the first target group and the at least one second target group via a chatbot; or
in a case that the information input interface is the information input interface of the target object in the data system, a predetermined module in the data system performs the determining, in response to reception of first information at an information processing interface, a first target group of the first information, and determining at least one second target group based on the first target group of the first information, and the predetermined module sends the first message derived based on the first information to the first target group and the at least one second target group via a chatbot.

According to one or more embodiments of the disclosure, [example 13] provides the method of [example 1], in which the first target group is a group bound with the information processing interface; or
the first target group is a group bound with a type of the first information.

According to one or more embodiments of the disclosure, [example 14] provides an information processing method, comprising:
determining, in response to reception of first information at a communication interface of a first group, a target identifier bound with the first group and a set of groups bound with the target identifier;
determining at least one second group based on an association relationship between the first group and respective groups in the set of groups; and
sending a first message derived based on the first information to the first group and the at least one second group.

According to one or more embodiments of the disclosure, [example 15] provides the method of [example 14], in which the determining at least one second group based on an association relationship between the first group and respective groups in the set of groups is carried out in such a manner that
the set of groups includes a general group and at least one sub-group;
in a case that the first group is the general group, the at least one second group excludes sub-groups of the general group;
in a case that the first group is the sub-group, the at least one second group includes the general group of the sub-group.

According to one or more embodiments of the disclosure, [example 16] provides the method of [example 14], in which the determining at least one second group based on an association relationship between the first group and respective groups in the set of groups comprises:
determining, based on a subscription relationship of the first group, at least one first subscribing group having subscribed to the first group from among the set of groups, the at least one second group including a group in the at least one first subscribing group;
or, determining, based on a subscription relationship of the first group, at least one first subscribing group having subscribed to the first group from among the set of groups, and determining at least one second subscribing group from among the at least one first subscribing group, the second subscribing group being configured with a preset information synchronization condition and the first information satisfying the preset information synchronization condition, and the at least one second group including groups in the at least one second subscribing group.

According to one or more embodiments of the disclosure, [example 17] provides an information processing apparatus, comprising:
a first determining unit configured to determine, in response to reception of first information at an information processing interface, a first target group of the first information, and determine at least one second target group based on the first target group of the first information; and
a first sending unit configured to send a first message derived based on the first information to the first target group and the second target group;
wherein the information processing interface is an interface other than a communication interface of the first target group and a communication interface of the second target group.

According to one or more embodiments of the disclosure, [example 18] provides an information processing apparatus, comprising:
a second determining unit configured to determine, in response to reception of first information at a communication interface of a first group, a target identifier bound with the first group and a set of groups bound with the target identifier, and determine at least one second group based on an association relationship between the first group and respective groups in the set of groups; and
a second sending unit configured to send a first message derived based on the first information to the first group and the at least one second group.

According to one or more embodiments of the disclosure, [example 19] provides a terminal, comprising: at least one memory and at least one processor;
wherein the at least one memory stores program codes, and the at least one processor is configured to invoke the program codes stored on the at least one memory to perform the method according to any of [example 1] to [example 16].

According to one or more embodiments of the disclosure, [example 20] provides a computer-readable storage medium, having program codes stored thereon, which, when executed by a processor, cause the processor to perform the method according to any of [example 1] to [example 16].

What have been described above are only illustrations of the preferred embodiments of the disclosure and the technical principles applied thereby. Those skilled in the art should understand that the scope of the disclosure herein is not limited to a technical solution formed by specific combinations of the technical features described supra, which should also encompass other technical solutions formed by any combination of the above technical features or equivalent features without departing from the idea described supra, e.g., a technical solution formed by mutual substitution between the above features and the technical features with similar functions as disclosed (but not limited to) herein.

In addition, although various operations are described in a specific order, it should not be construed such that these operations must be performed in the specific order as illustrated or in a sequential order. In certain circumstances, multi-task parallel processing can be advantageous. Likewise, although a plurality of specific implementation details have been described supra, these details should not be construed as limiting the scope of the disclosure. Some features described within the context of individual embodiments may also be combined to be implemented in a single embodiment. In turn, various features described within the context of a single embodiment may also be implemented in a plurality of embodiments separately or in any appropriate sub-combination manner.

Although the subject matter has been described with languages specific to structural features and/or method logic actions, it would be understood that the subject matter limited in the appended claims is not necessarily limited to the specific features or actions described supra. On the contrary, the specific features and actions described supra are only exemplary forms of implementing the claims.

1. An information processing method, comprising:
determining, in response to reception of first information at an information processing interface, a first target group of the first information, and determining at least one second target group based on the first target group of the first information; and
sending a first message derived based on the first information to the first target group and the at least one second target group;
wherein the information processing interface is an interface other than a communication interface of the first target group and a communication interface of the second target group.

2. The method according to claim 1, wherein
the first information is information of a target object; and
determining at least one second target group based on the first target group of the first information comprises: determining at least one object-associated group which is associated with the first target group via the target object, the at least one second target group including groups in the at least one object-associated group.

3. The method according to claim 2, wherein
the at least one second target group comprises a group associated with the first target group via the target object and associated with other groups via other objects.

4. The method according to claim 1, wherein
the first information is information of a target object, and at least one object-associated group which is associated with the first target group via the target object is configured with a first preset condition; and
determining at least one second target group based on the first target group of the first information comprises: determining the at least one object-associated group which is associated with the first target group via the target object, and determining, from among the at least one object-associated group, at least one condition-associated group configured with the first preset condition with the first information satisfying the first preset condition, the at least one second target group including the at least one condition-associated group.

5. The method according to claim 1, wherein determining at least one second target group based on the first target group of the first information comprises that
in a case that the first target group of the first information is a general group having sub-groups, the second target group excludes the sub-groups; or
in a case that the first target group of the first information is a sub-group of a general group, the at least one second target group includes the general group.

6. The method according to claim 1, wherein determining at least one second target group based on the first target group of the first information comprises:
determining at least one first subscribing group having subscribed to the first target group based on a subscription relationship of the first target group, the at least one second target group including groups in the at least one first subscribing group.

7. The method according to claim 1, wherein
determining at least one second target group based on the first target group of the first information comprises: determining, based on a subscription relationship of the first target group, at least one second subscribing group having subscribed to messages satisfying a second preset condition in the first target group, the at least one second target group including groups in the at least one second subscribing group, and the first information satisfying the second preset condition.

8. The method according to claim 7, wherein
the second preset condition is set in the first target group; or
the second preset condition is set in the second subscribing group.

9. The method according to claim 1, wherein
the first message includes an entry control for joining the first target group.

10. The method according to claim 1, wherein
in a case that a current user creating the first information has joined the first target group, the first message is sent in the first target group via an account of the current user; otherwise, the first message is sent in the first target group via a chatbot, with the user identifier of the current user being displayed; and/or, in a case that the current user has joined the second target group, the first message is sent in the second target group via the account of the current user; otherwise, the first message is sent in the second target group via the chatbot, with the user identifier of the current user being displayed;
or,
the first message is sent in the first target group and the second target group via the chatbot, with the user identifier of the current user being displayed.

11. The method according to claim 1, wherein
the first information is first information of a target object;
the information processing interface includes an information input interface that includes an information input interface of the target object displayed in a mini program; or an information input interface of the target object in a data system.

12. The method according to claim 11, wherein
in a case that the information input interface is the information input interface of the target object displayed in the mini program, the mini program performs the determining, in response to reception of first information at an information processing interface, a first target group of the first information, and determining at least one second target group based on the first target group of the first information, and the mini program sends the first message derived based on the first information to the first target group and the at least one second target group via a chatbot; or
in a case that the information input interface is the information input interface of the target object in the data system, a predetermined module in the data system performs the determining, in response to reception of first information at an information processing interface, a first target group of the first information, and determining at least one second target group based on the first target group of the first information, and the predetermined module sends the first message derived based on the first information to the first target group and the at least one second target group via a chatbot.

13. The method according to claim 1, wherein
the first target group is a group bound with the information processing interface; or
the first target group is a group bound with a type of the first information.

14. An information processing method, comprising:
determining, in response to reception of first information at a communication interface of a first group, a target identifier bound with the first group and a set of groups bound with the target identifier;
determining at least one second group based on an association relationship between the first group and respective groups in the set of groups; and
sending a first message derived based on the first information to the first group and the at least one second group.

15. The method according to claim 14, wherein determining at least one second group based on the association relationship between the first group and respective groups in the set of groups comprises that
the set of groups includes a general group and at least one sub-group;
in a case that the first group is the general group, the at least one second group excludes sub-groups of the general group; and
in a case that the first group is a sub-group, the at least one second group includes the general group of the sub-group.

16. The method according to claim 14, wherein determining at least one second group based on the association relationship between the first group and respective groups in the set of groups comprises:
determining, based on a subscription relationship of the first group, at least one first subscribing group having subscribed to the first group from among the set of groups, the at least one second group including groups in the at least one first subscribing group;
or, determining, based on a subscription relationship of the first group, at least one first subscribing group having subscribed to the first group from among the set of groups, and determining at least one second subscribing group from among the at least one first subscribing group, the second subscribing group being configured with a preset information synchronization condition and the first information satisfying the preset information synchronization condition, and the at least one second group including groups in the at least one second subscribing group.

17. (canceled)

18. (canceled)

19. An electronic device, comprising:
at least one memory and at least one processor;
wherein the at least one memory stores program codes that, in response to execution by the at least one processor, cause the electronic device to:
determine, in response to reception of first information at an information processing interface, a first target group of the first information, and determine at least one second target group based on the first target group of the first information; and
send a first message derived based on the first information to the first target group and the at least one second target group;
wherein the information processing interface is an interface other than a communication interface of the first target group and a communication interface of the second target group.

20. A non-transitory computer-readable storage medium having program codes stored thereon, which, when executed by a processor, causes the processor to perform the method according to claim 1.

21. The electronic device according to claim 19, wherein the first information is information of a target object; and
wherein the electronic device being caused to determine the at least one second target group based on the first target group of the first information includes being caused to determine at least one object-associated group which is associated with the first target group via the target object, the at least one second target group including groups in the at least one object-associated group.

22. The electronic device according to claim 21, wherein
the at least one second target group comprises a group associated with the first target group via the target object and associated with other groups via other objects.
